(19) United States
(12) Patent Application Publication
(10) Pub. No.: US 2012/0087503 A1
(43) Pub. Date: Apr. 12, 2012

(54) MULTI-CHANNEL AUDIO OVER STANDARD WIRELESS PROTOCOL

(75) Inventors: Clarke S. Watson, San Carlos, CA (US); Benjamin W. Cook, San Francisco, CA (US); Axel D. Berny, San Francisco, CA (US); Jason A. Trachewsky, Menlo Park, CA (US)

(73) Assignee: Passif Semiconductor Corp., San Mateo, CA (US)

(21) Appl. No.: 13/267,557

(22) Filed: Oct. 6, 2011

Related U.S. Application Data
(60) Provisional application No. 61/390,865, filed on Oct. 7, 2010.

(51) Int. Cl. H04R 5/02; H04R 5/00

(52) U.S. Cl. 381/23; 381/307

(57) ABSTRACT

A wireless multi-channel audio system including an audio source with a wireless transceiver configured to communicate according to a standard wireless protocol and an audio controller, which are collectively configured to establish wireless communications with multiple audio sinks via a corresponding wireless link, to assign each audio sink a corresponding audio channel, to synchronize timing with each audio sink, and to transmit audio information for each audio channel to a corresponding audio sink via a corresponding wireless link. The audio source may inquire as to supported audio parameters, such as sample rate and audio codec, and selects a commonly supported configuration. The audio source may separate audio information into queues for each audio channel for each audio sink. The audio source transmits frames with timestamps and a common start time for synchronization, and the audio sinks use this information to synchronize timing and remain virtually synchronized with each other.

### CROSS-REFERENCE TO RELATED APPLICATIONS

This application claims the benefit of U.S. Provisional Application Ser. No. 61/390,865, filed on Oct. 7, 2010 which is herein incorporated by reference in its entirety for all intents and purposes.

### BACKGROUND OF THE INVENTION

1. Field of the Invention

The present invention relates generally to a wireless multi-channel audio system used to deliver separate audio channels to multiple wireless loudspeakers via separate wireless links, and to synchronize playback of the audio information.

2. Description of the Related Art

The most common type of wireless stereo audio loudspeakers consists of a single radio frequency (RF) transceiver delivering audio to separate left and right loudspeakers via a wired connection. The term “loudspeaker” as used herein refers to any electro-acoustic transducer and includes, but is not limited to, home and professional audio speakers and headphones, earphones, ear buds, etc. The audio system may use a standard wireless protocol, such as Wi-Fi (based on the IEEE 802.11 family of standards of the Institute of Electrical and Electronics Engineers) or the like. The term “standard wireless protocol” or “standard protocol” as used herein refers to any open or publicly available wireless protocol or any wireless protocol that is a product of a standards body or special interest group, which includes but is not limited to Bluetooth and Wi-Fi. The term “proprietary wireless protocol” or “proprietary protocol” as used herein refers to any wireless protocol other than a standard wireless protocol. Less common configurations are wireless loudspeakers that consist of separate RF receivers for the left and right audio channel. These loudspeakers use proprietary wireless protocols only.

A significant disadvantage of wireless stereo loudspeakers that use a proprietary wireless protocol is that a separate RF transmitter must be added to the audio source since the audio source does not otherwise support the proprietary protocol. These RF transmitters are typically in the form of a dongle, which plugs into the audio source. The dongle adds bulk to portable systems, and shortens battery life if it draws power from the audio source. If the dongle has its own power source, then it becomes one more item that requires recharging or battery replacement, both of which are undesirable in terms of the end-user experience.

A significant disadvantage of using IEEE 802.11 Wi-Fi to deliver multi-channel audio to separate loudspeakers is that the protocol was not designed to distribute synchronized audio to multiple RF receivers. Specifically, methods to minimize latency and to ensure that playback is synchronized at all loudspeakers are not covered in any part of the protocol specification. Therefore, current systems that use IEEE 802.11 incorporate a single RF receiver that has a wired connection to the left and right loudspeakers.

Other issues related to conventional configurations will become apparent to one of ordinary skill in the art after comparing such prior art with the present invention as described herein.

### BRIEF DESCRIPTION OF THE DRAWINGS

The benefits, features, and advantages of the present invention will become better understood with regard to the following description, and accompanying drawings where:

FIG. 1 is a block diagram of a wireless audio system implemented according to an exemplary embodiment of the present invention including two channels;

FIG. 2 is a block diagram of another wireless audio system implemented according to another exemplary embodiment of the present invention including six channels;

FIG. 3 is a simplified block diagram of an exemplary audio source according to one embodiment which may be used to implement either or both of the audio sources of FIGS. 1 and 2;

FIG. 4 is a simplified block diagram of an exemplary audio sink according to one embodiment which may be incorporated within any of the loudspeakers of FIGS. 1 and 2;

FIG. 5 is a flowchart diagram illustrating operation of the audio source of FIG. 3 according to one embodiment for communicating with one or more audio sinks in a wireless medium;

FIG. 6 is a flowchart diagram illustrating operation of the audio sink of FIG. 4 according to one embodiment while communicating with the audio source of FIG. 3 operating according to the flowchart of FIG. 5 in a wireless medium;

FIGS. 7-11 are block diagrams of exemplary frames wirelessly communicated between the audio source of FIG. 3 and the audio sink of FIG. 4 according to one embodiment, including a discovery request frame, a discovery response frame, a synchronization request frame, a synchronization response frame, and an audio block frame;

FIG. 12 is a message sequence diagram illustrating discovery, synchronization, audio transport and audio playback for a stereo audio system according to one embodiment;

FIGS. 13 and 14 are simplified figurative block diagrams illustrating a synchronization process according to one embodiment which is performed by the audio source of FIG. 3 and the audio sink of FIG. 4 (representing each audio sink in an audio system), respectively, to establish and maintain timing synchronization; and

FIG. 15 is a figurative block diagram illustrating the results of the synchronization process performed between the audio source of FIG. 3 operating according to the flowchart of FIG. 5 and each audio sink implemented according to FIG. 4 and configured according to the flowchart of FIG. 6.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present disclosure describes a wireless multi-channel audio system in which a standard wireless protocol is used to deliver audio data to untethered (wireless) loudspeakers. In one embodiment, the standard wireless protocol is according to IEEE 802.11 Wi-Fi, although alternative standard protocols currently in use or later developed are also contemplated. A multi-channel audio system as described herein eliminates the need for a wired connection between the loudspeakers without requiring a proprietary wireless protocol to the audio source. Various embodiments disclosed herein incorporate an audio source and two or more loudspeakers acting as audio sinks. The audio source has a direct wireless connection to each audio sink according to the standard wireless protocol. In one embodiment, the wireless connection may consist of station-to-station links (STSL) when an access point is available, or it may use Wi-Fi Direct when an access point is unavailable or it is undesirable to involve the access point in the wireless audio system.

Although the audio information may be broadcast or multicast to the audio sinks, such configuration may be unreliable since broadcast or multicast frames are not acknowledged. Also, the audio information of all of the channels may be sent by unicast or directed frames, but this would require the same data to be transmitted to each audio sink separately resulting in wasted wireless bandwidth. Instead, according to embodiments described herein, the audio data or information is separated into audio channels, and each audio channel is transmitted to a corresponding audio sink via a corresponding wireless link.

The audio source uses a discovery mechanism to determine which audio sinks are available and to determine the capabilities of each. Audio playback is synchronized over multiple channels by first establishing a common time reference between the audio source and each audio sink. Once a common time reference is established, audio transmission may begin and synchronization is maintained by including timestamp information within each frame of audio data in order to allow each audio sink to update its local time reference. The audio data may be transmitted in either compressed or uncompressed formats. The bandwidth provided by IEEE 802.11 is more than sufficient for the distribution of multi-channel uncompressed audio.

The audio source may set up a regular transmit schedule so that each sink determines when to wake up to listen for its data. Alternatively, each sink may determine how long it may sleep after receiving a frame based on the timestamp of the audio frame among other possible factors. These methods allow the receiver in the audio sink to sleep for a period of time between each audio frame in order to reduce device power consumption. The term “sleep” refers to a device state of reduced power consumption as compared to that under normal operation. The sleep state may involve reducing clock frequency to one or more circuits, gating clocks to one or more circuits, and/or gating power to one or more circuits, or any other technique that reduces power consumption.

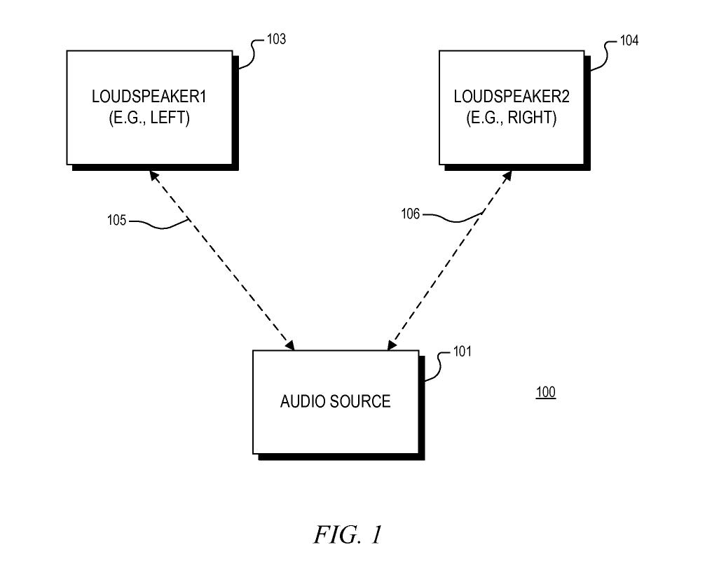

FIG. 1 is a block diagram of a wireless audio system 100 implemented according to an exemplary embodiment of the present invention. The wireless audio system 100 includes an audio source 101, a first loudspeaker 103 (LOUDSPEAKER1) and a second loudspeaker 104 (LOUDSPEAKER2), and may otherwise be referred to as a wireless stereo audio system with two audio channels. The specific configuration of the audio source 101 and each of the loudspeakers 103 and 104 depends upon the particular application, which may have any one of several forms. The audio source 101 may be implemented as any one of a mobile phone (e.g., Blackberry, iPhone, etc.), a portable game player, a portable media player (e.g., MP3 player, iPod, etc.), a computer (e.g., Personal or Professional Computer or PC, Apple or Mac computer, etc.), an audio/video (A/V) receiver as part of a home entertainment or home theater system, etc. An A/V receiver, for example, may have both wired and wireless loudspeakers, in which the loudspeakers 103 and 104 may be wireless rear channel speakers or the like. The loudspeakers 103 and 104 are configured as any type of electro-acoustic transducers for converting audio information into sound, such as home or professional speakers, headphones, earphones, ear buds, etc. The present invention is not limited to any particular physical format or size of the audio source and speaker configuration. The loudspeaker 103 may be a left channel speaker and the loudspeaker 104 may be a right channel speaker, or vice-versa, in which either loudspeaker may be configured for either stereo channel.

A separate wireless link is provided between the audio source 101 and each loudspeaker 103 and 104. As shown, for example, a wireless link 105 is established between the audio source 101 and the loudspeaker 103 and a separate wireless link 106 is established between the audio source 101 and the loudspeaker 104. As further described herein, the loudspeakers 103 and 104 and the audio source 101 each include a wireless transceiver for enabling wireless communications. The wireless communications are implemented according to a standard wireless protocol, such as, for example, Wi-Fi or Wi-Fi Direct or the like. Each of the loudspeakers 103 and 104 may generally be referred to as an audio sink for receiving and processing audio information as further described herein.

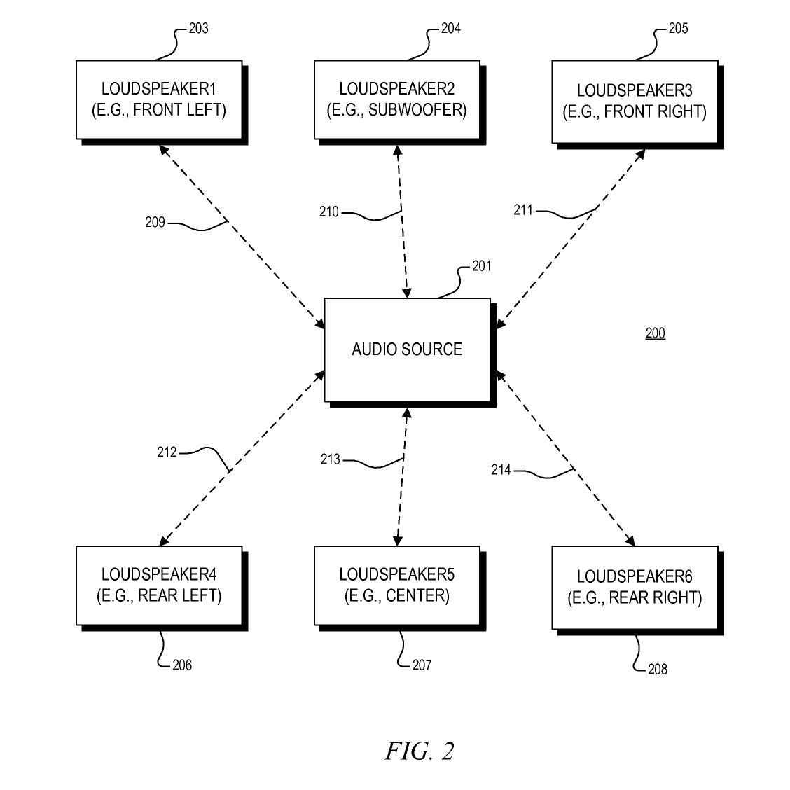

Although only two loudspeakers are shown in FIG. 1, any number of loudspeakers may be included. FIG. 2, for example, is a block diagram of another wireless audio system 200 implemented according to another exemplary embodiment of the present invention. The wireless audio system 200 includes six (6) loudspeakers 203, 204, 205, 206, 207, and 208 with corresponding wireless links 209, 210, 211, 212, 213, and 214, respectively, with the audio source 201, for implementing the six audio channels. In a similar manner, the loudspeakers 203-208 and the audio source 201 each include a wireless transceiver for enabling wireless communications. The wireless communications are implemented according to a standard wireless protocol, such as, for example, Wi-Fi or Wi-Fi Direct or the like. The wireless audio system 200 provides for a distribution of 5.1 multi-channel surround sound, in which there is one audio source and six audio sinks. The loudspeakers may be listed as front left, subwoofer, front right, rear left, center and rear right for the 5.1 multi-channel surround sound, although alternative configurations are contemplated. For example, 7.1 multi-channel surround sound is contemplated as well using eight audio channels. Each of the loudspeakers may generally be referred to as an audio sink for receiving and processing audio information as further described herein.

Wi-Fi does not currently have a standard “profile” for the distribution of audio. The transport of audio data over Wi-Fi may use one or more proprietary frame formats. A protocol for use with Wi-Fi is described herein which enables multi-channel audio over Wi-Fi for any of the embodiments described herein. Similar protocols and mechanisms may be employed for any standard wireless protocol.

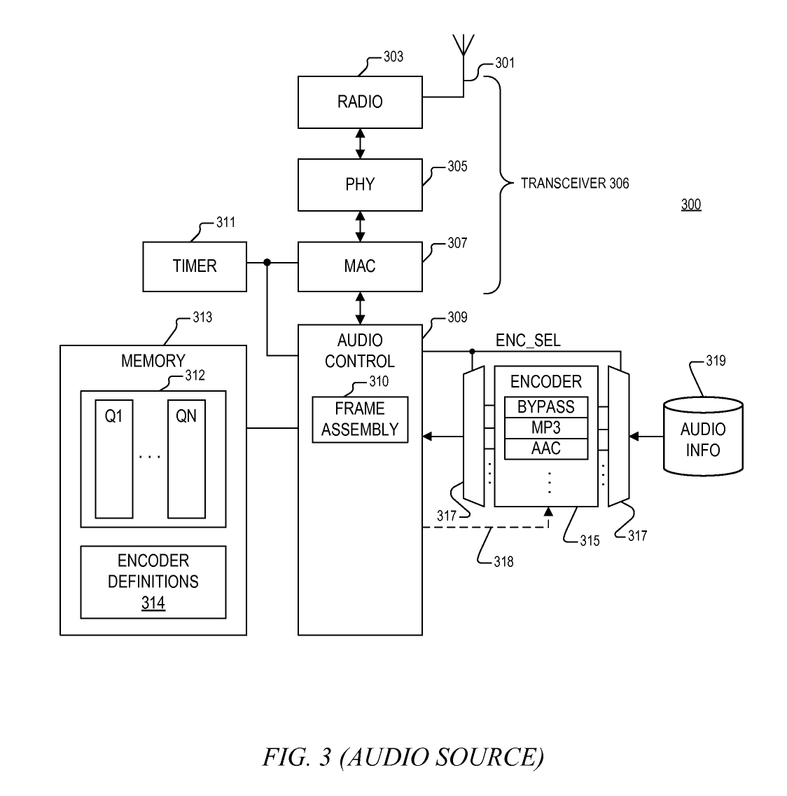

FIG. 3 is a simplified block diagram of an exemplary audio source 300 according to one embodiment which may be used to implement either or both of the audio sources 101 and 201. The audio source 300 includes a radio 303 which wirelessly communicates via an antenna 301. A physical layer (PHY) block 305 interfaces the radio 303 to a media access control (MAC) block 307, which further interfaces an audio controller 309. The radio 303, PHY 305 and MAC 307 collectively implement a wireless transceiver 306. A memory 313 is coupled to the audio controller 309 for storing any combination of data and software or other information for operating the audio source 300. A timer 311 is coupled to the MAC block 307 and the audio controller 309 for synchronizing audio communication and playback as further described herein. The audio controller 309 includes a frame assembly block 310 which configures frames for establishing communication with one or more audio sinks, and for sending audio frames incorporating audio information to the audio sinks.

Audio information is shown stored in an audio database 319 or file or the like, in which the audio information is provided to the audio controller 309 via a selected one of one or more encoders within an encoder block 315. In one embodiment, the encoder block 315 includes multiple encoders, such as an MP3 encoder, an advanced audio coder (AAC) encoder, etc., and the audio controller 309 controls select logic 317 via one or more encoder select signals ENC_SEL to select one of the encoders to encode the audio information and to provide encoded audio information to the audio controller 309. The encoder block 315 may also include a BYPASS path selected by the select logic 317 when the audio information is already encoded according to a particular format, or when it is desired to send uncompressed audio information. In an alternative embodiment, the encoder block 315 is programmable according to a selected encoder definition from one or more encoder definitions 314 stored within the memory 313. The audio controller 309 retrieves an encoder definition from the memory 313 and programs the encoder block 315 accordingly to encode the audio information according to the selected format.

The audio controller 309 enqueues the encoded (or uncompressed) audio information into one or more queues of a queue block 312, which is shown implemented within the memory 313. The queue block 312 includes one queue per audio channel. As shown, the queue block 312 includes “N” queues Q1 . . . QN for N channels (e.g., 2, 6, 8, etc.). It is understood that the memory 313 may be implemented with multiple memory devices. Also, the individual queues Q1-QN of the queue block 312 may be centralized in one memory space or device or distributed in separate memory spaces or devices. The term “memory” generally encompasses any of these various configurations and embodiments. The audio controller 309 determines the number of channels and implements a corresponding number of queues within the memory 313. The frame assembly block 310 assembles audio block frames as further described herein for sending audio information to each audio sink from the corresponding queue of the queue block 312. The queue block 312 may be programmable to include any number of queues for the corresponding number of audio sinks. For the wireless audio system 100, for example, the queue block 312 may be configured to include a first queue (Q1) for storing audio data for a first audio channel for transmitting to the first loudspeaker 103 via the wireless link 105, and a second queue (Q2) for storing audio data for a second audio channel for transmitting to the loudspeaker 104 via the wireless link 106. For the wireless audio system 200, for example, the queue block 312 may be configured with six different queues including one queue for each of six different audio channels for transmitting via corresponding wireless links 209-214 to each of the loudspeakers 203-208, respectively.

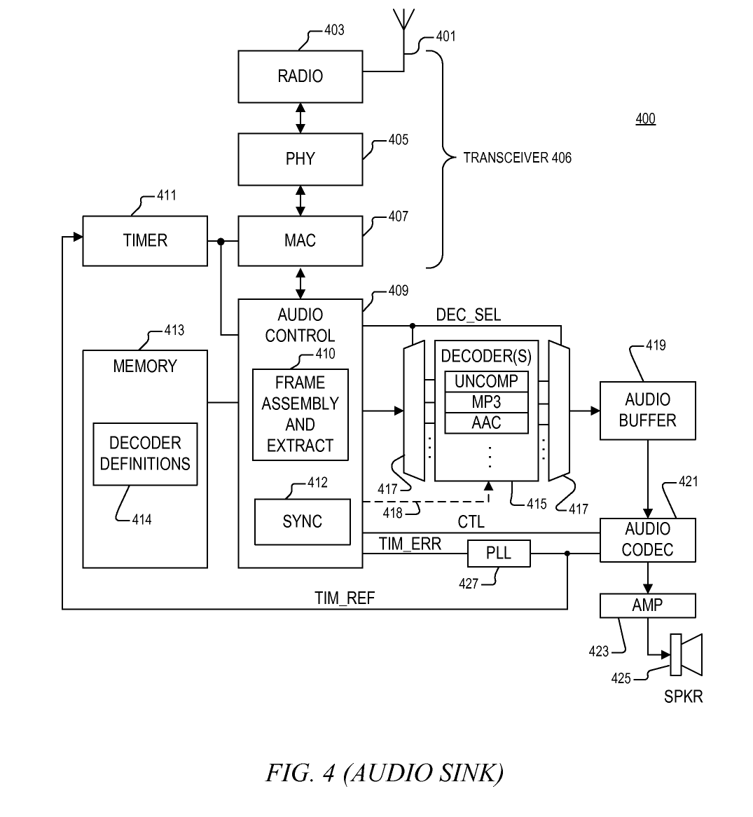

FIG. 4 is a simplified block diagram of an exemplary audio sink 400 according to one embodiment, which may be incorporated within any of the loudspeakers 103-104 or 203-208. The audio sink 400 also includes a radio 403, which wirelessly communicates via an antenna 401. A PHY block 405 interfaces the radio 403 to a MAC block 407, which further interfaces an audio controller 409. The radio 403, PHY 405 and MAC 407 collectively implement a wireless transceiver 406. A memory 413 is coupled to the audio controller 409 for storing any combination of data and software or other information for operating the audio sink 400. A timer 411 is coupled to the MAC 407 and to the audio controller 409 for synchronizing audio communication and playback as further described herein. The audio controller 409 includes a frame assembly and extract block 410, which configures frames for establishing communication with the audio source 300, and for receiving and extracting communication parameters and audio information as further described herein. The audio controller 409 further includes a synchronization (SYNC) block 412 for synchronizing audio playback as further described herein.

Audio information extracted from received audio frames is provided to an audio buffer 419 via a selected one of one or more decoders within a decoder block 415. In one embodiment, the decoder block 415 includes multiple decoders, such as an MP3 decoder, an AAC decoder, etc., and the audio controller 409 controls select logic 417 via one or more decoder select signals DEC_SEL to select one of the decoders to decode the audio information and to provide decoded audio information for temporary storage within the audio buffer 419. During playback, an audio codec 421 retrieves decoded audio information from the audio buffer 419 and provides the audio information to a speaker 425 via an amplifier 423. The audio controller 409 provides one or more control (CTL) signals to the audio codec 421 to control initiation and other parameters of playback, and the timing of the playback process is controlled by a phase-locked loop (PLL) 427. The SYNC block 412 develops a timing error (TIM_ERR) signal, which is provided to adjust the PLL 427. The PLL 427 provides a timing reference (TIM_REF) signal to the audio codec 421 to control timing of playback of the audio information. TIM_REF is fed back to the timer 411 for synchronization as further described herein.

The decoder block 415 may also include a BYPASS path selected by the select logic 417 when the audio information is not encoded or uncompressed. In an alternative embodiment, the decoder block 415 is programmable according to a selected decoder definition from one or more decoder definitions 414 stored within the memory 413. The audio controller 409 retrieves a decoder definition from the memory 413 and programs the decoder block 415 to decode the audio information according to the selected format.

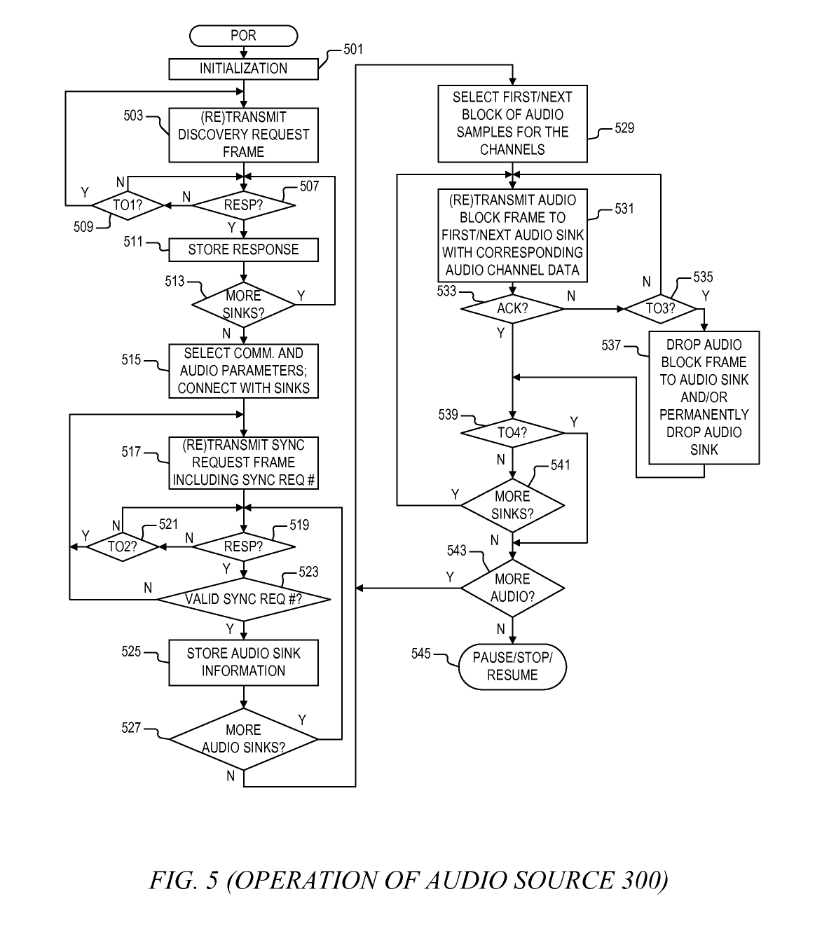

FIG. 5 is a flowchart diagram illustrating operation of the audio source 300 according to one embodiment for communicating with the audio sinks in a wireless medium. In one embodiment, each audio sink is configured according to the audio sink 400, although alternative configurations are contemplated. Upon power on or reset (POR), an initialization process at block 501 may be performed to initiate operations of the audio source 300. At next block 503, a discovery request frame is transmitted by the audio source 300 to identify available audio sinks. The discovery request frame may be broadcast in the wireless medium to be retrieved by the available audio sinks in the area covered by wireless communications. In one embodiment, the discovery request frame may identify the audio source 300 and is capabilities.

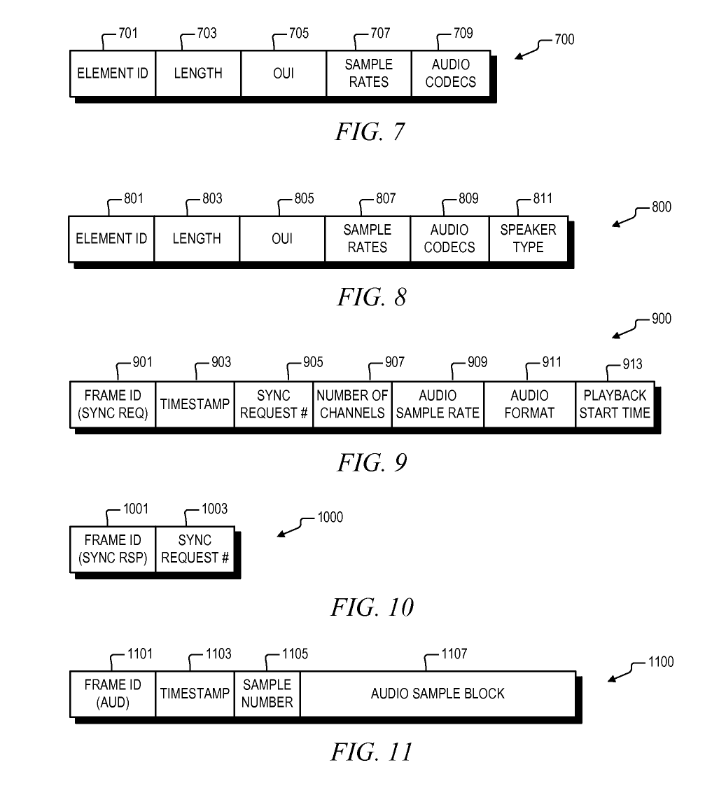

FIG. 7 is a block diagram illustrating an exemplary discovery request frame 700 according to one embodiment. The discovery request frame 700 includes multiple fields each including one or more information elements (IE) provided to the audio sinks. These information elements may be vendor-specific information elements, such as defined in the IEEE Std 802.11-2007 section 7.3.2.26 or the like. One field 701 includes element identification (ID) information which may identify the frame as a discovery request frame and which may identify the audio source 300. Another field 703 includes a length parameter which provides the length of the frame. Another field 705 includes an organizationally unique identifier (OUI) which uniquely identifies a vendor, manufacturer, etc., and which generally identifies the wireless protocol being employed. Another field 707 provides information or identification of one or more sample rates supported by the audio source 300. Another field 709 provides information or identification of one or more audio codecs supported by the audio source 300.

In an alternative, preconfigured embodiment, the discovery request frame may be simplified in which the supported sample rates and/or audio codecs are not included. In this case, the audio source 300 and each of the audio sinks may be preconfigured according to a predetermined sample rate and/or audio codec. In this case, the discovery request frame may be primarily used to initiate communications with the audio sinks.

Referring back to FIG. 5, operation advances to block 507 in which the audio source 300 listens for responses from available audio sinks, in which each response is in the form of a discovery response frame. The audio source 300 initiates a time period TO1, and operation loops between blocks 507 and 509 until a response is received or timeout of the time period TO1 occurs. If timeout of the time period TO1 occurs before a response is received from each and every audio sink, operation loops back to block 503 to retransmit (re-broadcast) the discovery request frame. The time period TO1 is selected based on the amount of time expected to receive a discovery response frame from each and every audio sink. In an alternative embodiment the number of audio sinks may be programmable, or the audio source 300 operates as long as a minimum number of audio sinks have responded within a predetermined time period.

FIG. 8 is a block diagram illustrating an exemplary discovery response frame 800 according to one embodiment. The discovery response frame 800 includes multiple fields each including one or more information elements (IE) provided to the audio source. One field 801 includes element ID information which may identify the frame as a discovery response frame and which may further identify the audio sink responding to the discovery request frame. Another field 803 includes a length parameter which provides the length of the frame. Another field 805 includes the OUI as previously described. Another field 807 provides information or identification of one or more sample rates supported by the audio sink. Another field 809 provides information or identification of one or more audio codecs supported by the audio sink. In the preconfigured embodiment, the discovery response frame may be simplified by not including the supported audio codecs and/or sample rates since this information is predetermined.

Another field 811 provides information or identification of the speaker type associated with the particular audio sink. With reference to the wireless audio system 100, for example, the speaker type may indicate the left loudspeaker or the right loudspeaker associated with corresponding left and right channels. With reference to the wireless audio system 200, for example, the speaker type may indicate the front left loudspeaker, the subwoofer, the front right loudspeaker, the rear left loudspeaker, the center loudspeaker, or the rear right loudspeaker associated with corresponding audio channels.

Referring back to FIG. 5, operation proceeds to block 511 when a discovery response frame is received, and the audio source 300 stores the information received associated with the corresponding audio sink. For example, the audio source 300 stores one or more sample rates and audio codecs supported by the corresponding audio sink. The audio source 300 may further assign an audio channel based on the speaker type and create or otherwise identify a corresponding queue for the audio channel and corresponding audio sink. At next block 513, the audio source inquires whether there are additional audio sinks that have not yet responded. If so, operation loops back to blocks 507 and 509 to listen for the next response. In one embodiment, the audio system has a predetermined number of audio sinks (e.g., 2, 6, 8, etc.) and the audio source 300 does not proceed until the predetermined number of audio sinks has responded. In another embodiment, the audio source 300 may be configured to proceed when a sufficient number of audio sinks have responded within a suitable time period sufficient for any available audio sinks to respond.

When the expected (or a sufficient) number of audio sinks has responded with discovery response frames as determined at block 513, operation proceeds to block 515 in which the audio source 300 gathers each of the discovery responses received and determines the set of capabilities to use. For example, the audio source 300 selects the appropriate communication parameters for wireless communications, and further selects the audio parameters suitable for audio playback. For example, the audio source 300 selects a sample rate and an audio codec supported by each of the audio sinks. If more than one sample rate is supported by the audio source 300 and each of the audio sinks, then the audio source may select the highest supported sample rate to optimize playback. Referring back to FIG. 3, for example, the audio controller 309 of the audio source 300 asserts ENC_SEL to select the encoder type of the encoder block 315 according to the selected audio codec. Alternatively, the audio controller 309 programs the encoder block 315 as previously described.

At this time, each audio channel of the audio information may be assigned to a corresponding queue within the queue block 312, and further associated with a corresponding wireless link to the corresponding audio sink. For example, for the wireless audio system 100, the left channel audio data is assigned a first queue and further associated with the wireless link 105, and the right channel audio data is assigned a second queue and further associated with the wireless link 106. A similar assignment and association process is performed for the wireless audio system 200 (e.g., each audio channel assigned to one of six queues and associated with one of the wireless links 209-214 for a corresponding one of the loudspeakers 203-208).

The audio source 300 then establishes at block 515 a wireless connection (or link) with each audio sink after all of the audio sinks that have responded. Establishing a wireless connection may involve a negotiation process with each audio sink to determine optimal communication parameters according to the wireless protocol standard, and may further include establishment of encryption keys or the like if the wireless links are to be secure. As further described below, the audio source 300 may send a connection request or the like during the connection process.

Operation then proceeds to block 517 in which the audio source 300 transmits a synchronization request frame to establish timing synchronization between the audio source 300 and each of the audio sinks. The synchronization request frame may be broadcast (e.g., broadcast destination address) or multicast (e.g., multicast destination address including each of the audio sinks).

FIG. 9 is a block diagram illustrating an exemplary synchronization request frame 900 according to one embodiment. The synchronization request frame 900 includes a field 901 including a frame identifier (ID) or the like identifying the frame as a synchronization request (SYNC-REQ) frame to the audio sinks. Fields 903 and 905 include a timestamp or the like and a synchronization request number (SYNC REQUEST #), respectively, which are both used for purposes of synchronizing the audio sinks with the audio source 300 as further described herein. In this manner, the audio sinks of the audio system are synchronized with the audio source 300, and thus virtually synchronized with each other for synchronized audio playback as further described herein. The time tracking mechanism for providing the timestamp may account for rollover to allow for a finite width timestamp. Fields 907, 909, 911 and 913 of frame 900 provide the number of channels, the selected audio sample rate, the selected audio format and the playback start time, respectively, to be used in the audio system for playback of the audio information. The audio sample rate and format may be excluded for a preconfigured embodiment. The audio format determines whether the audio information is compressed or uncompressed, and the type of compression (e.g., MP3, AAC, etc.) if compressed. In this manner, each of the audio sinks operate in separate channels yet at the same sample rate and audio format, and each is synchronized to begin playback at the same time. The audio source 300 determines the time at which audio playback begins to be far enough into the future to allow each of the audio sinks to indicate they are synchronized and to buffer up some amount of audio samples, as further described herein.

Referring back to FIG. 5, operation advances to block 519 in which the audio source 300 listens for responses from the audio sinks, in which each response is in the form of a synchronization response frame. An audio sink that received a synchronization request frame responds with a corresponding synchronization response frame indicating that it is ready to receive audio information. The audio source 300 initiates a time period T02, and operation loops between blocks 519 and 521 until a response is received from each audio sink or timeout of the time period TO2 occurs. The time period TO2 is selected based on the amount of time expected to receive a synchronization response frame from each and every audio sink that has been discovered. Wireless channel occupancy or adverse wireless medium conditions may interfere with the ability of each audio sink to respond within the time period TO2. If timeout of the time period TO2 occurs before each audio sink has responded with a valid response, operation loops back to block 517 to retransmit (broadcast or multicast) the synchronization request frame with an updated synchronization request number. The time period TO2 is restarted for each newly transmitted synchronization request frame.

FIG. 10 is a block diagram illustrating an exemplary synchronization response frame 1000 according to one embodiment. The synchronization response frame 1000 includes a field 1001 including a frame ID or the like identifying the frame as a synchronization response (SYNC-RSP) frame and further identifying the audio sink. The synchronization response frame 1000 further includes a field 1003 which includes a copy of the synchronization request number retrieved from field 905 of the synchronization request frame 900 which was previously transmitted by the audio source 300. Since the audio source 300 may potentially transmit more than one synchronization request frame, the synchronization request number is used to ensure that the audio sink has received that latest synchronization request frame as identified in the corresponding synchronization response frame.

Referring back to FIG. 5, when an audio sink responds with a synchronization response frame 1000, operation proceeds to block 523 in which the audio source 300 compares the synchronization request number retrieved from the synchronization response frame 1000 with the synchronization request number from the last transmitted synchronization request frame. As previously noted, poor or marginal wireless conditions may interfere with transmissions and responses causing a timeout of the time period TO2 before each of the audio sinks have responded, in which case the audio source 300 re-transmits a new synchronization request frame with an updated (new) synchronization request number. If the synchronization request numbers do not match as determined at block 523, then the corresponding audio sink did not receive the latest synchronization request frame and operation loops back to block 517 to re-transmit another synchronization request frame with a new synchronization request number and the time period TO2 is restarted.

If the synchronization request numbers match as determined at block 523, then operation proceeds to block 525 in which the audio source 300 stores the information for that audio sink. It is noted that audio channel assignment and wireless link association described as being performed at block 515 may alternatively be performed at block 525. Operation then proceeds to block 527 in which the audio source 300 determines whether all of the audio sinks have responded with valid synchronization request numbers. If there are any audio sinks which have not yet responded, then operation loops back to block 519 to listen for the next response. Operation loops between blocks 519-527 until each of the audio sinks have responded with valid synchronization request frames or until timeout of time period T02. The number of synchronization response frames expected by the audio source 300 is equivalent to the number of channels in the request. For example, with stereo audio, the source expects two response frames, in 5.1 surround sound, the source expects six response frames, in 7.1 surround sound, the source expects eight response frames, etc.

When all of the expected audio sinks have responded with valid synchronization response frames as determined at block 527, operation proceeds to block 529 in which the audio source 300 selects the first (or next) set or block of audio samples within the queue block 312 for each of the channels to be transmitted to the corresponding audio sinks. In one embodiment, the audio samples are distributed among the queues within the queue block 312 on a per-channel basis since each channel receives different, albeit associated or temporally aligned audio data. In this manner, the selected block of audio samples spans the queues and includes associated audio information for each of the channels. Operation then proceeds to block 531 in which the audio source 300 selects the first (or next) audio sink to send corresponding audio channel data within a corresponding audio block frame. Each audio block frame is a directed or unicast frame to one selected audio sink. Operation then proceeds to block 533 in which the audio source 300 waits for an acknowledgement (ACK) from the audio sink. In one embodiment, audio block frames may be acknowledged using standard acknowledgement (e.g. after each audio block frame). In an alternative embodiment, block acknowledgement is contemplated. The audio source 300 initiates a first time period TO3 representing a maximum amount of time to wait for an ACK from a given audio sink, and also initiates a second, longer time period TO4 representing a maximum amount of time for transmitting an audio block frame to each of the audio sinks.

FIG. 11 is a block diagram illustrating an exemplary audio block frame 1100 according to one embodiment. The audio block frame 1100 includes a field 1101 including a frame ID or the like identifying the frame as an audio block frame (AUD). The audio block frame 1100 further includes a field 1103 providing a timestamp used for purposes of synchronization as further described herein. The audio block frame 1100 further includes a field 1105 providing a sample number. In one embodiment, the sample number tracking mechanism accounts for rollover to allow for a finite width sample number. The audio block frame 1100 further includes a field 1107 storing the audio sample block. The audio sample block includes multiple audio samples for a selected audio channel which are extracted by a corresponding audio sink for playback. The sample number indicates the number of the first sample in the audio sample block in the current frame. Each audio sink tracks audio information progress using the sample number and the number of samples in the audio sample block as further described herein.

Referring back to FIG. 5, a relatively short predetermined ACK time period may be used to listen for each ACK from the audio sink at block 533. If the audio sink does not respond with an ACK within the predetermined ACK time period, then operation proceeds to block 535 to determine whether the first time period TO3 has expired. If not, then operation loops back to block 531 in which the audio source 300 re-transmits the first audio block frame to the first audio sink. If the time period TO3 expires before an ACK is received from the audio sink, then operation proceeds instead to block 537. In this manner, unacknowledged audio block frames are retransmitted up to expiration of the time period TO3. At block 537, the transmission of the current audio block frame to the current audio sink is dropped to provide sufficient time to transmit associated audio information to the other audio sinks if not already handled, or to proceed with the next block of audio samples.

The audio source 300 may further track unacknowledged frames over time. If a given audio sink fails to respond to successive transmissions of different audio block frames then the audio source 300 may “permanently” drop that particular audio sink. The disappearance of an audio sink (due to power-down or malfunction) may contribute to many unnecessary retransmissions. If the audio source 300 detects that an audio sink is no longer responsive, it may halt all audio frames to that audio sink in order to save wireless bandwidth. It is noted that a user may make adjustments to the audio system and restart playback to re-establish and maintain wireless connection between the audio source 300 and all of the audio sinks if desired.

After an ACK is received at block 533, or after drop processing of block 537, operation proceeds to block 539 to determine whether the longer time period TO4 has expired. Again, the time period TO4 represents the maximum amount to time to attempt to transmit associated audio samples to all of the audio sinks. If TO4 has not yet expired, operation proceeds to block 541 to determine whether there are additional audio sinks yet to receive the associated audio samples. If there are more audio sinks as determined at block 541, then operation loops back to block 531 in which the audio source 300 transmits the corresponding audio channel data of the current block of audio samples to the next audio sink, and the TO3 period is re-started. Operation loops between blocks 531-541 until the audio channel data of the current block of audio samples has been transmitted (or transmission has been attempted) to each of the audio sinks or timeout of the time period TO4 has occurred. Upon timeout of T04, or when the current set of audio channel data has been transmitted (or at least attempted) to each of the audio sinks, operation proceeds to block 543 to determine whether there is more audio information to be transmitted. If so, operation loops back to block 529 in which the next block of audio samples for each of the channels is selected, and then to block 531 to fashion a corresponding audio block frame to the next audio sink. The time periods TO3 and TO4 are restarted. Operation loops between blocks 529-543 until all of the audio information has been transmitted to each of the audio sinks.

If or when there is no more audio information to be transmitted as determined at block 543, then operation proceeds to block 545 to pause or stop operations, or to resume operations for a different set of audio information as the case may be. The entire procedure may be repeated, for example, to playback another audio file or the like.

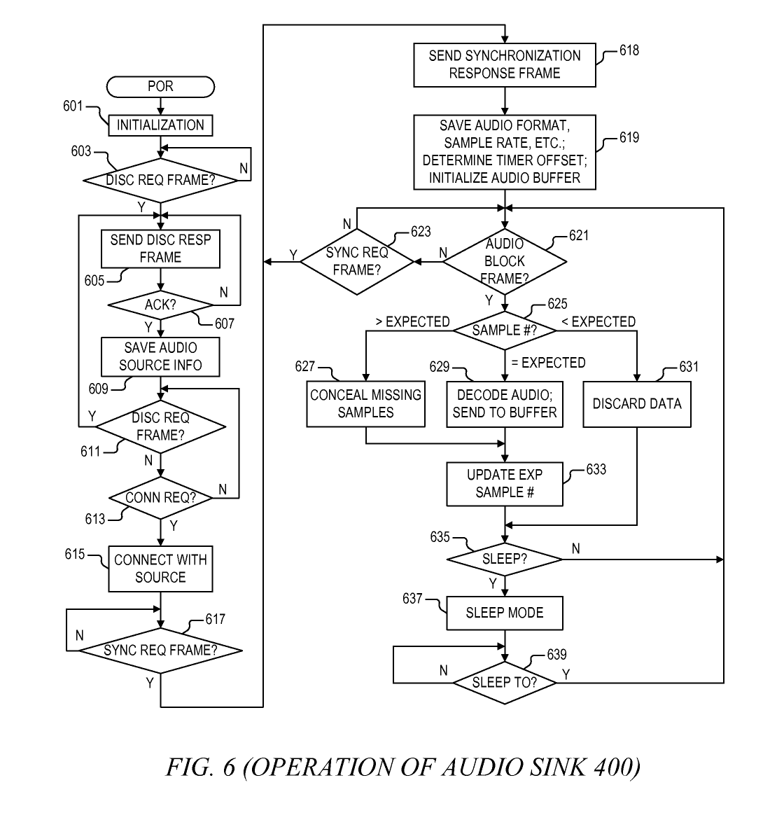

FIG. 6 is a flowchart diagram illustrating operation of the audio sink 400 according to one embodiment while communicating with the audio source 300 operating according to the flowchart of FIG. 5 in a wireless medium. The audio sink 400 represents any one or more of the loudspeakers 103-104 or 203-208. Upon POR, an initialization process at block 601 may be performed to initiate operations of the audio sink 400. At next block 603, the audio sink listens for a discovery request frame (DISC REQ FRAME, e.g., frame 700) from the audio source 300. Operation loops at block 603 until a discovery request frame is detected.

When a discovery request frame is detected, operation proceeds to block 605 in which the audio sink 400 responds with a discovery response frame (DISC RESP FRAME, e.g., frame 800). As previously described, the discovery response frame identifies the audio sink and its capabilities, such as supported sample rates and audio codecs and the like. In a preconfigured embodiment, the sample rate and audio codec is already known as previously described. The audio sink 607 waits for an ACK from the audio source 300 at next block 607 to acknowledge reception of the discovery response frame. If the ACK is not received, then operation loops back to block 605 to send another discovery response frame. Although operation may loop indefinitely waiting for a discovery response frame, a timeout may be employed to activate a sleep mode or even shut down if desired.

When an ACK is received, operation proceeds to block 609 in which the audio sink 400 saves information regarding the audio source 300, and then operation proceeds to loop between blocks 611 and 613 to listen for either another discovery request frame or a connection request (CONN REQ) from the audio source 300. As previously described, the audio source 300 may send another discovery request frame when at least one audio sink fails to properly respond within a given time period (e.g., TO1). Otherwise the audio source 300 sends a connection request and operation proceeds to block 615 in which the audio sink 400 negotiates with the audio source 300 to establish a wireless connection.

Operation then proceeds to block 617 in which the audio sink 400 listens for a synchronization request frame (SYNC REQ FRAME, e.g., frame 900) from the audio source 300. Operation loops at block 617 until a synchronization request frame is received. When a synchronization request frame is received, operation proceeds to block 618 in which a synchronization response frame (e.g., frame 1000) is sent to the audio source 300. The audio sink 400 extracts the synchronization request number from the synchronization request frame and inserts it into the synchronization response frame to determine validity of the response. Operation then proceeds to block 619 in which the audio sink 400 saves or stores the information from the synchronization request frame, including, for example, the selected audio format and sample rate (if not otherwise preconfigured), and the playback start time. The audio sink 400 may also extract the timestamp information from the synchronization request frame and uses the timestamp to determine a timer offset used for synchronization as further described herein.

Referring back to FIG. 4, the audio controller 409 of the audio sink 400 may also initialize the audio buffer 419 for playback of the audio information. The audio controller 409 may further assert the DEC_SEL signal to select the decoder of the decoder block 415 according to the selected audio codec. Alternatively, the audio controller 409 programs the decoder block 415 as previously described.

Referring back to FIG. 6, operation then proceeds to loop between blocks 621 and 623 to determine whether the next frame from the audio source 300 is either an audio block frame (e.g., frame 1100) or another synchronization request frame. If another synchronization request frame is received as determined at block 623, then at least one audio sink failed to send a valid synchronization response frame and the audio source 300 sends another synchronization request frame. In this case, operation loops back to block 618 to send another synchronization response frame and to save the audio communication parameters.

If instead the frame is an audio block frame as determined at block 621, then the audio sink 400 has completed the initial synchronization with the audio source 300 and begins buffering audio data in the audio buffer 419 until the playback start time. The audio information is synchronized across all audio channels since each of the audio sinks start their playback timer at approximately the same time. As previously described, the timestamp from the synchronization request frame 900 is used to determine a timer offset, and the timestamp from each audio block frame is used to update the timer for purposes of synchronization. The audio sink 400 extracts the sample number from the audio block frame, and operation proceeds to block 625 to compare the sample number extracted from the audio block frame with an expected sample value. Since the sample number indicates the number of the first sample in the audio sample block of the audio block frame, and the number of samples in the frame is readily determined, the audio sink 400 is able to track successive audio blocks and samples and thus determine the expected sample value.

If the sample number extracted from the audio block frame is the expected value, then the audio sink 400 provides the audio samples from the audio sample block to the decoder block 415 to decode the audio samples, and the decoded audio information is sent to and stored within the audio buffer 419 at block 629. At next block 633, the audio sink 400 updates the expected sample number. At next block 635, the audio sink 400 may determine whether to enter a sleep mode to save power and conserve energy. If so, operation proceeds to block 637 in which the audio sink 400 transitions to a low power or sleep mode, and then to block 639 to determine when to wake up from sleep or otherwise transition to normal power mode using a sleep timer or the like (e.g., wait for sleep timeout, SLEEP TO). Upon sleep timeout at block 639, operation loops back to block 621 to listen for the next audio block frame. If the audio sink 400 determines not to enter sleep mode, then operation loops back from block 635 to block 621 to listen for the next audio block frame.

In one embodiment, the audio source 300 may set up a regular transmit schedule such that each audio sink knows when to wake up to listen for its data. Alternatively, each audio sink may determine how long it may sleep after receiving an audio block frame based on the timestamp and other factors. These methods allow the receiver in the audio sink to sleep for a period of time between each audio frame in order to reduce device power consumption. The term “sleep” refers to a device state of reduced power consumption as compared to that under normal operation. The sleep state may involve reducing clock frequency to one or more circuits, gating clocks to one or more circuits, and/or gating power to one or more circuits, or any other technique that reduces power consumption.

Referring back to block 625, if the sample number retrieved from the audio block frame is greater than the expected sample number, then operation proceeds instead to block 627 in which the audio sink 400 takes the appropriate action to conceal the missing samples. In this case, one or more audio samples or sample blocks are presumed to have been missed so that appropriate or otherwise known methods are used to conceal the missing audio information to the extent possible while maintaining timing synchronization. Operation then proceeds to block 633 to update the expected sample number based on the new sample number.

Referring back to block 625, if the sample number retrieved from the audio block frame is less than the expected sample number, then operation proceeds instead to block 631 in which the audio sink 400 discards the audio samples since this information has presumably already been received and processed. Operation then proceeds to block 635 to determine whether to enter the sleep mode as previously described.

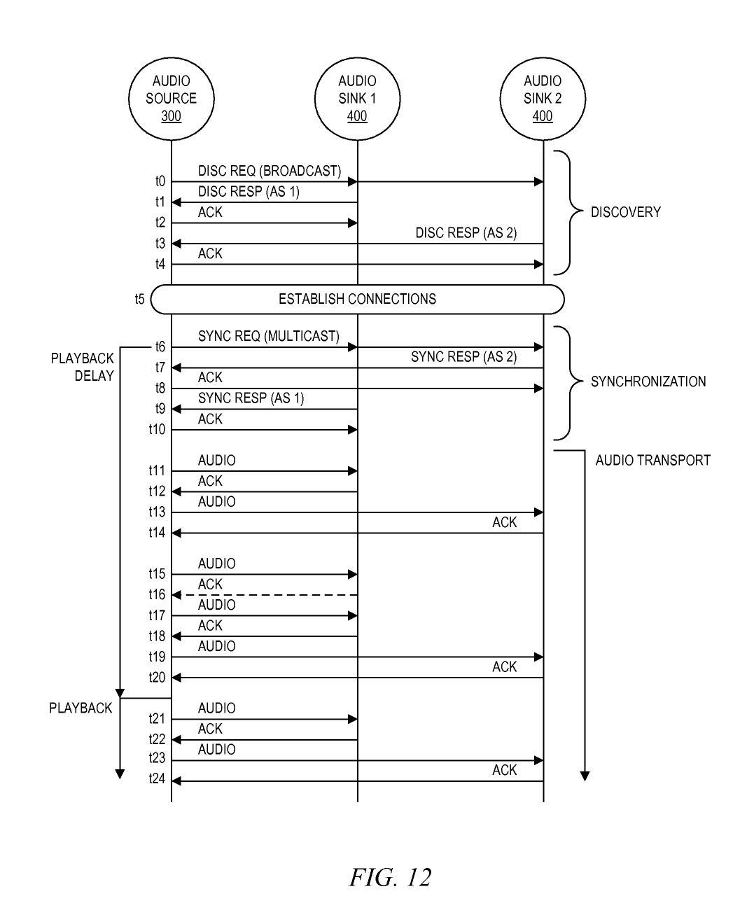

FIG. 12 is a message sequence diagram illustrating discovery, synchronization, audio transport and audio playback for a stereo audio system according to one embodiment. Although the system depicted is a stereo system with two channels, similar principles are operative regardless of the number of channels employed. Time is depicted from top to bottom. The stereo audio system includes an audio source 300 and a pair of audio sinks 400, individually shown as audio sink 1 and audio sink 2. At a first time t0, the discovery process begins when the audio source 300 transmits (e.g., broadcasts) a discovery request frame in the wireless medium, which is received by both audio sinks 1 and 2. Audio sink 1 (AS 1) responds with a discovery request frame at time t1, which is acknowledged (ACK) by the audio source 300 at time t2. Audio sink 2 (AS 2) responds with a discovery request frame at time t3, and the audio source 300 responds with an ACK at time t4. Assuming the frames are successfully sent and received, this completes the discovery process. The audio source 300 then establishes wireless connections (links) with the audio sinks 1 and 2 as depicted at a time t5.

At subsequent time t6, the synchronization process begins with the audio source 300 transmitting (e.g., multicast) a synchronization request frame. The synchronization request frame may be multicast as shown, although a broadcast transmission may be used as well. The synchronization request frame includes a playback start time as previously described, and each audio sink 400 initiates a playback delay beginning at about time t6. Audio sink 2 responds with a synchronization response frame at time t7 and the audio source 300 responds with an ACK at time t8. Similarly, audio sink 1 responds with a synchronization response frame at time t9 and the audio source 300 responds with ACK at time t10. Assuming the frames are successfully sent and received, this completes the synchronization process.

At about time t11, the audio transport process begins in which the audio source 300 sends an audio block frame to the audio sink 1, where the audio sink 1 responds with an ACK at time t12. The audio source 300 sends another audio block frame with associated audio information to the audio sink 2 at time t13, and audio sink 2 responds with an ACK at time t14. The audio source 300 sends the next block of audio samples via an audio block frame to the audio sink 1 at time t15, and audio sink 1 responds with an ACK at time t16. The ACK at time t16 is shown with a dashed line depicting failure of reception by the audio source 300. Thus, the audio source 300 retries the same audio block frame at subsequent time t17, which is successfully acknowledged by the audio sink 1 at time t18. The audio source 300 then sends the associated block of audio samples via an audio block frame to the audio sink 2 at time t19, and audio sink 2 responds with an ACK at time t20.

Shortly after time t20, the playback delay timers timeout and each of the audio sinks 400 begin playing the received and buffered audio information. The audio transport process nonetheless continues in the same manner, in which the audio source 300 sends the next block of audio samples in another audio block frame to the audio sink 1 at time t21, which is acknowledged by the audio sink 1 at time t22. The audio source 300 then sends the associated block of audio samples via an audio block frame to the audio sink 2 at time t23, and audio sink 2 responds with an ACK at time t24. Operation continues in this manner while there is additional audio information to be transmitted to and played by the audio sinks 400.

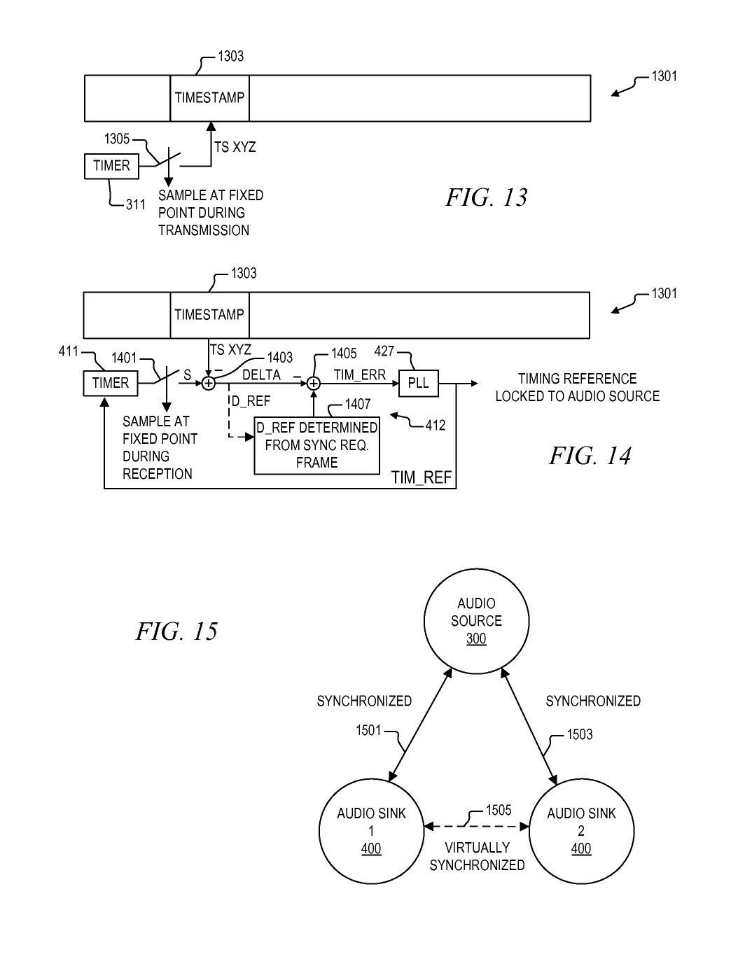

FIGS. 13 and 14 are simplified figurative block diagrams illustrating a synchronization process according to one embodiment which is performed by the audio source 300 and the audio sink 400 (representing each audio sink in the audio system), respectively, to establish and maintain timing synchronization. The timer 311 of the audio source 300 is shown in FIG. 13 and the timer 411 is shown in FIG. 14, in which both timers are free-running timers. The timer 311 is sampled by a sample switch 1305 for determining a timestamp (TS) value shown as TS XYZ. The sample switch 1305 represents the action performed by the MAC block 307 during formation and transmission of a frame 1301. The timer 311 is sampled at a “fixed” point during the transmission process, and the sampled timing value (e.g., TS XYZ) is inserted as the TIMESTAMP value into the appropriate field 1303 of the frame 1301. A fixed point means that the sample is taken at the same time for each frame being transmitted with a timestamp value, including each synchronization request frame 900 and each audio block frame 1100. Thus the frame 1301 represents each synchronization request frame 900 and each audio block frame 1100 that is transmitted by the audio source 300.

The MAC block 407 includes a sample switch 1401 and the SYNC block 412 includes combiners (e.g., adders) 1403 and 1405 and a memory 1407 (e.g., register or the like). The sample switch 1401 represents the action performed by the MAC block 407 during reception of the frame 1301. Each time a transmitted version of the frame 1301 is received by the audio sink 400, the TIMESTAMP value (e.g., TS XYZ) is retrieved from field 1303 of the frame 1301 and provided to one input of the combiner 1403. The sample switch 1401 samples the timer 411 at a “fixed” point during the frame receive process and a sample value S is provided to the other input of the combiner 1403. Again, a fixed point means that the sample value S is taken from the timer 411 at the same time during the frame receive process for each frame being received with a timestamp value, including each synchronization request frame 900 and each audio block frame 1100. The combiner 1403 determines the difference between the sample value S and the timestamp value (e.g., TS XYZ) to provide a DELTA value at its output. As shown, the combiner 1403 subtracts TS XYZ from the sample value S to calculate the DELTA value.

When the frame 1301 is a synchronization request frame 900, the DELTA value is determined and stored as a delta reference value D_REF within the memory 1407. When instead the frame 1301 is a audio block frame 1100, the combiner 1405 subtracts the DELTA value provided by the combiner 1403 from the D_REF value stored in the memory 1407 and the combiner 1405 provides the difference as a timing error value TIM_ERR at its output. The TIM_ERR value is provided to adjust the PLL 427, which outputs the timing reference signal TIM_REF at its output. The TIM_REF is further fed back to control the rate at which timer 411 advances. In this manner, the relative timing between the timers 311 and 411 is locked so that the TIM_REF value is locked to the corresponding timing reference of the audio source 300.

When a synchronization request frame 900 is transmitted by the audio source 300 and received by the audio sink 400, the initially determined D_REF value represents a timing differential between the timers 311 and 411. When a subsequent audio block frame 1100 is transmitted by the audio source 300 and received by the audio sink 400, a new DELTA value is computed. If for any reason the timer 411 has independently sped up relative to the timer 311, then the new DELTA value is greater than the previously determined D_REF value and the TIM_ERR value goes negative. A negative TIM_ERR value slows down the TIM_REF generated by PLL 427, and therefore the timer 411 slows down as well. If instead the timer 411 has independently slowed down relative to the timer 311, then the TIM_ERR value is positive. A positive TIM_ERR value speeds up the TIM_REF generated by PLL 427, and therefore the timer 411 speeds up as well. In this manner, the SYNC block 412 of each audio sink 400 operates to minimize the TIM_ERR value in an attempt to maintain the relative time difference between the timers 311 and 411 at a constant level.

It is noted that although the synchronization process described in FIGS. 13-14 may be performed according to a variety of different methods, it is advantageous that the timers, the sampling of the timers and insertion of the timestamp values occur in hardware in order to ensure the greatest accuracy.

FIG. 15 is a figurative block diagram illustrating the results of the synchronization process performed between the audio source 300 operating according to the flowchart of FIG. 5 and each audio sink 400 configured according to the flowchart of FIG. 6. As shown, the audio source 300 communicates with first and second audio sinks 400, shown individually as audio sink 1 and audio sink 2. The SYNC block 412 of the audio sink 1 operates to synchronize it with the audio source 300 as depicted by arrow 1501, and the SYNC block 412 of the audio sink 2 operates to synchronize it with the audio source 300 as depicted by arrow 1503. Since each audio sink 1 and 2 is synchronized with the common audio source 300, then the audio sinks 1 and 2 are virtually synchronized with each other, as depicted by dashed arrow 1505.

Referring back to FIG. 1, the first and second loudspeakers 103 and 104 each synchronize with the audio source 101, so that the loudspeakers 103 and 104 are virtually synchronized with each other so that playback of the separate audio channels is coherent. Referring back to FIG. 2, each of the loudspeakers 203-208 synchronize with the audio source 201, so that the loudspeakers 203-208 are virtually synchronized with each other so that playback of the separate audio channels is coherent.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A wireless multi-channel audio system, comprising:
an audio source, comprising:
a source wireless transceiver configured to communicate according to a standard wireless protocol; and
a source audio controller; and
wherein said source wireless transceiver and said source audio controller are collectively configured to:
establish wireless communications with each of a plurality of audio sinks via a corresponding one of a plurality of wireless links;
assign each audio sink a corresponding one of a plurality of audio channels;
synchronize timing with each of said plurality of audio sinks; and
transmit audio information for each of said plurality of audio channels to a corresponding one of said plurality of audio sinks via a corresponding one of said plurality of wireless links.

2. The wireless multi-channel audio system of claim 1, wherein said standard wireless protocol comprises Wi-Fi.

3. The wireless multi-channel audio system of claim 1, wherein said audio source is configured to transmit a request frame with audio parameters supported by said audio source, and is configured to receive a plurality of response frames each incorporating supported audio parameters.

4. The wireless multi-channel audio system of claim 3, wherein said audio parameters include at least one sample rate and at least one audio codec, and wherein said audio controller is configured to select a sample rate and an audio codec.

5. The wireless multi-channel audio system of claim 1, wherein said audio source further comprises:
a memory; and
wherein said audio controller implements a plurality of queues within said memory, and wherein each queue stores audio information for a corresponding one of said plurality of audio channels.

6. The wireless multi-channel audio system of claim 1, wherein said audio source further comprises at least one encoder for encoding uncompressed audio information to provide encoded audio information.

7. The wireless multi-channel audio system of claim 1, wherein said audio source further comprises:
a plurality of encoders; and
select logic controlled by said audio controller for selecting one of said plurality of encoders.

8. The wireless multi-channel audio system of claim 1, wherein said audio source further comprises a programmable encoder.

9. The wireless multi-channel audio system of claim 1, wherein said audio source is configured to transmit a plurality of frames via each of said plurality of wireless links, and wherein each of said plurality of frames includes a timestamp.

10. The wireless multi-channel audio system of claim 9, wherein at least one of said plurality of frames incorporates a common playback start time.

11. The wireless multi-channel audio system of claim 9, wherein said audio source further comprises:
a source timer; and
wherein said source wireless transceiver samples said source timer at a fixed time during transmission of each of said plurality of frames to generate a corresponding timestamp.

12. The wireless multi-channel audio system of claim 11, wherein at least one of said plurality of audio sinks comprises:
a sink timer;
a sink wireless transceiver which samples said sink timer at a fixed time during reception of each of said plurality of frames and which provides a corresponding sample value;
at least one adder which subtracts a timestamp included in each of said plurality of frames from a corresponding sample value to provide a corresponding delta value;
a memory which stores a first delta value as a reference value;
wherein said at least one adder subtracts each subsequent delta value from said reference value to provide a corresponding timing error value; and
timing circuitry which adjusts a timing reference based on said timing error value, wherein said timing reference is used to adjust timing of said sink timer.

13. The wireless multi-channel audio system of claim 1, wherein each of said plurality of audio sinks synchronize timing with said audio source and are virtually synchronized with each other.

14. The wireless multi-channel audio system of claim 1, wherein at least one of said plurality of audio sinks comprises at least one decoder for decoding received audio information to provide uncompressed audio information.

15. The wireless multi-channel audio system of claim 1, wherein at least one of said plurality of audio sinks comprises:
a plurality of decoders; and
select logic for selecting one of said plurality of decoders.

16. The wireless multi-channel audio system of claim 14, wherein at least one of said plurality of audio sinks comprises a programmable decoder.

17. A wireless multi-channel audio system, comprising:
an audio sink, comprising:
a wireless transceiver configured to communicate according to a standard wireless protocol;
an audio controller;
an audio buffer;
an audio conversion device; and
a loudspeaker; and
wherein said wireless transceiver and said audio controller are collectively configured to:
establish wireless communications with an audio source via a wireless link;
synchronize timing with said audio source;
receive audio information associated with one of a plurality of audio channels from said audio source via said wireless link and to store corresponding audio data into said audio buffer; and
provide said audio data for processing by said audio conversion device for conversion by said loudspeaker beginning at a playback start time received from said audio source.

18. The wireless multi-channel audio system of claim 17, wherein said audio sink further comprises:
a timer;
wherein said wireless transceiver samples said timer at a fixed time during reception of each of a plurality of frames transmitted by said audio source and provides a corresponding sample value;
at least one adder which subtracts a timestamp included in each of said plurality of frames from a corresponding sample value to provide a corresponding delta value;
a memory which stores a first delta value as a reference value;
wherein said at least one adder subtracts each subsequent delta value from said reference value to provide a corresponding timing error value;
timing circuitry which adjusts a timing reference based on said timing error value, wherein said timing reference is used to adjust timing of said timer; and
wherein said audio conversion device controls timing of processing of said audio data based on said timing reference.

19. The wireless multi-channel audio system of claim 17, wherein said audio sink is configured to respond to a request frame from said audio source with a response frame including audio parameters supported by said audio sink.

20. The wireless multi-channel audio system of claim 17, wherein said audio sink is configured to respond to a synchronization request frame from said audio source with a synchronization response frame which includes a duplicate of a synchronization request number provided within said synchronization request frame.

21. The wireless multi-channel audio system of claim 17, wherein said audio sink is configured to track progress of audio data received in a plurality of audio block frames transmitted by said audio source using a sample number provided within each of said plurality of audio block frames.
